(19) United States
(12) Patent Application Publication
(10) Pub. No.: US 2026/0147528 A1
(43) Pub. Date: May 28, 2026

(54) AUDIO CONTROL BASED ON WIRELESS INFORMATION

(71) Applicant: Comcast Cable Communications, LLC, Philadelphia, PA (US)

(72) Inventors: Brian FLICKER, Springfield, PA (US); Daniel ZERUMSKY, Elkins Park, PA (US)

(21) Appl. No.: 18/898,087

(22) Filed: Sep. 26, 2024

(51) Int. Cl. G06F 3/16; H04B 17/318

(52) U.S. Cl. CPC G06F 3/165; H04B 17/318

(57) ABSTRACT

Methods and systems are described for providing content. Wireless information, such as signal strength information, may be associated with corresponding volume levels for outputting content. The wireless information may be an indication of a number of people in an area of a premises. If the wireless information changes over time, then the volume levels for outputting the content may be adjusted.

### BACKGROUND

A user listening to audio, such as audio accompanying a video, may adjust the volume to account for ambient noise at the premises. However, the ambient noise at a premises may not be constant. In some cases, the ambient noise may increase and disrupt the user's ability to hear the audio. Changes in the ambient noise may cause the user to have to continually change volume. Thus, there is a need for more sophisticated techniques for changing the volume of audio without requiring the user to change the volume.

### SUMMARY

Methods and systems for providing content are disclosed. A computing device may monitor wireless information, such as signal strength information, associated with a premises. The wireless information may comprise wireless metrics associated with a wireless communication between the computing device and one or more other computing devices at the premises, such as user devices, premises devices, network devices, and/or the like. The wireless information may be analyzed to determine changes in the wireless information that may be indicative of a change in ambient noise. In some scenarios, an increase in the number of people in a room may cause an increase in ambient noise and also cause a corresponding change in signal strength information. If a threshold amount of change in the wireless information is detected, then the computing device may cause a corresponding change (e.g., increase, decrease) in volume level associated with output of content at the premises.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example system.

FIG. 2A shows a view of an example premises.

FIG. 2B shows another view of an example premises.

FIG. 3 shows an example method.

FIG. 4 shows an example method.

FIG. 5 shows an example method.

FIG. 6 is a block diagram illustrating an example computing device.

### DETAILED DESCRIPTION OF ILLUSTRATIVE EMBODIMENTS

Audio volume associated with content (e.g., audio content, video content) may be too low or high due to ambient noise changes in a premises (e.g., home). Changes in ambient noise may cause the user to have to continually change volume. The ambient noise at the premises may increase or decrease due to a heater, air conditioner, weather, a change in the number of people present, a combination thereof, and/or the like. When changes in the ambient noise occur, a user may need to increase the volume in order to hear the content the user is accessing. In some cases, ambient volume may decrease, in which case the volume may be too high, causing the user to have to lower the volume. This can be annoying to the user. The present disclosure relates to techniques for using wireless information to cause changes in volume various content. The wireless information may be correlated to specific volume levels. In some scenarios, the wireless information may be used to estimate a number of people in a room where the content is being accessed. The wireless information may comprise received signal strength indicator (RSSI) information, signal strength information, Wi-Fi motion information, channel state information, and/or the like.

The wireless information may also be used with other information, such as ambient noise levels (e.g., detected via microphone), or other sensor information (e.g., camera information, door opening and/or close, motion sensor information, infrared sensor information). A computing device, such as a television, set-top box, or other device, may have access to a microphone continually sampling the background noise level, a wireless transceiver sampling wireless information, or a combination thereof. Based upon a predetermined algorithm to prevent continual volume changes, the computing device may be configured to increase the volume by X amount if an increase of X amount is detected. By increasing/decreasing the volume of content after an increase/decrease in background noise is detected, the user can enjoy content without interruption.

Volume levels may be determined based on user history. Volume control patterns over time may be stored to learn user patterns (e.g., volume down during commercials, up when show resumes, etc.) so that the system can ultimately control volume based on the level at which the user has set the volume. A computing device may combine the patterns with detected changes in wireless information. The volume may be changed to reflected changes in wireless information. The changes to the volume may be overridden (e.g., temporarily) if an event is detected, such as a user leaving a room, a commercial break, and/or the like. For example, if wireless information indicates an increase in ambient noise, the volume level may be increased. The amount of the increase may be based on user volume patterns and/or saved preferences of the user. Other events, such as detection of a commercial and/or a user leaving an area (e.g., room) of the premises, may cause the volume to be lowered. If the event is over (e.g., user enters the room, commercial break is over), the volume may be returned to the increased level.

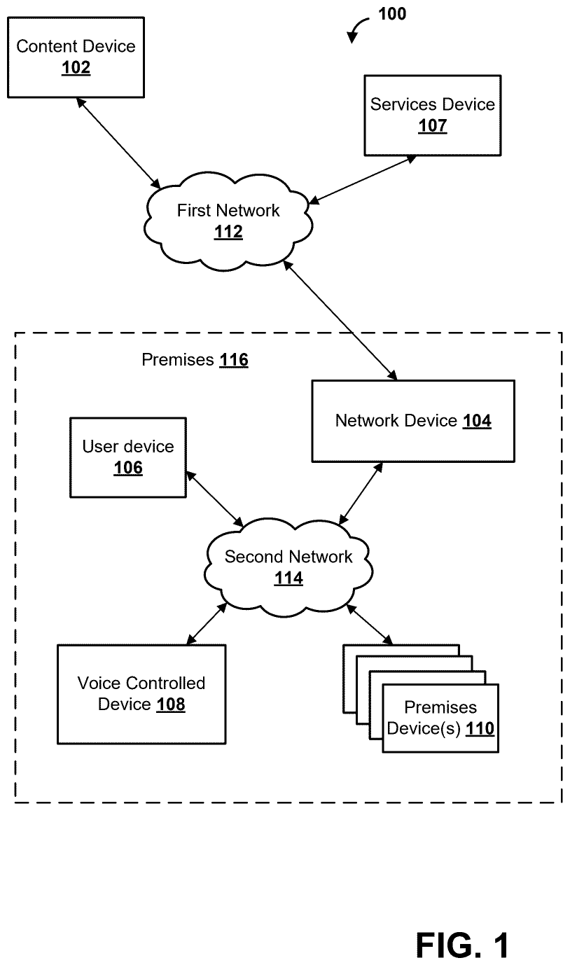

FIG. 1 shows a block diagram of an example system 100. The system 100 may comprise a content device 102 (e.g., content server, edge device), a network device 104 (e.g., gateway device, a termination system, a cable modem termination system, a network node, or combination thereof), a user device 106, a services device 107, a voice controlled device 108, one or more premises devices 110, or a combination thereof. It should be noted that while the singular term device is used herein, it is contemplated that some devices may be implemented as a single device or a plurality of devices (e.g., via load balancing). The content device 102, the network device 104, the user device 106, the services device 107, the voice controlled device 108, the one or more premises devices 110 may each be implemented as one or more computing devices. Any device disclosed herein may be implemented using one or more computing nodes, such as virtual machines, executed on a single device and/or multiple devices.

The content device 102, the network device 104, the user device 106, the services device 107, the voice controlled device 108, and/or the one or more premises devices 110 may be communicatively coupled via one or more networks, such as a first network 112 (e.g., a wide area network) and one or more second networks 114 (e.g., one or more local area networks). The first network 112 may comprise a content distribution and/or access network. The first network 112 may facilitate communication via one or more communication protocols. The first network 112 may comprise fiber, cable, a combination thereof. The first network 112 may comprise wired links, wireless links, a combination thereof, and/or the like. The first network 112 may comprise routers, switches, nodes, gateways, servers, modems, and/or the like.

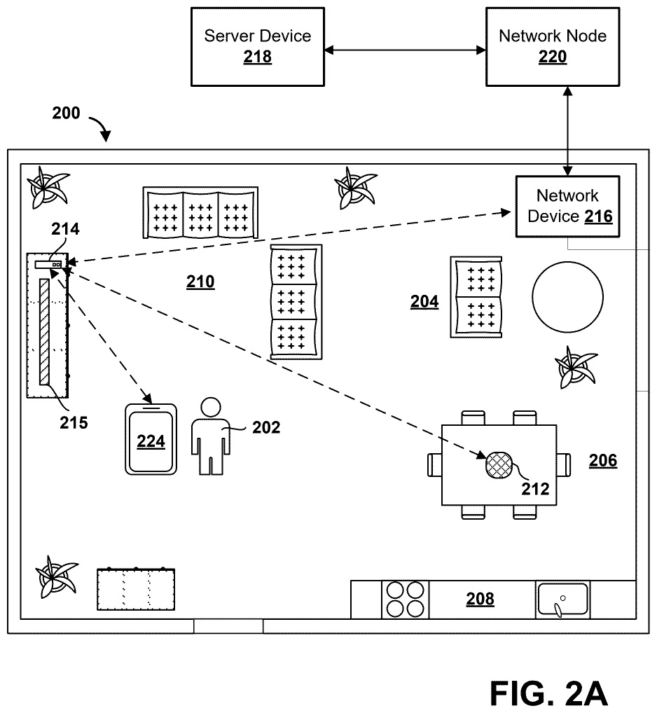

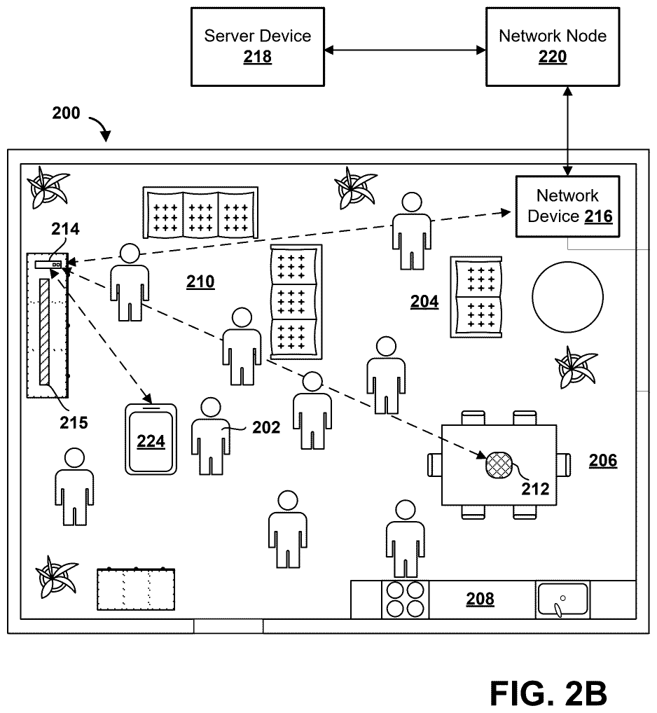

The one or more second networks 114 may comprise one or more networks in communication with the network device 104, the user device 106, the voice controlled device 108, and/or the one or more premises devices 110. In some scenarios, any combination of the user device 106, the network device 104, or the voice controlled device 108 may be implemented as a single device. The one or more second networks 114 may comprise one or more networks at a premises 116. The premises 116 may be a customer premises. The premises 116 may include an area within a coverage range (e.g., wireless range) of the network device 104. The premises 116 may comprise a property, dwelling, terminal, building, floor, and/or the like. The premises 116 may comprise different rooms, walls, door, windows, and/or the like (e.g., as shown in FIGS. 2A-B). The user device 106 may move within the premises 116 and/or outside of the premises.

The one or more premises devices 110 may be located at the premises 116. The one or more premises devices 110 may comprise one or more of a wireless extender, an access point, a camera, a sensor, a security system, a security controller, a gateway device, a smoke detector, a heat sensor, infrared sensor, infrared emitter, infrared camera, a door sensor, a motion sensor, a window sensor, a thermostat, a microphone, a personal assistant, a door lock, an irrigation device, or a combination thereof. The one or more premises devices 110 may be configured to generate premises data. The premises data may comprise a sensor state, a setting, audio, video, images, text information, premises mode, or a combination thereof. The premises data may comprise thermal data, such as heat sensor data, data of an infrared sensor (e.g., data for each of a plurality of pixels of the sensor), a thermal signature, a combination thereof, and/or the like. The one or more premises devices 110 may be configured to send the premises data to the services device 107, the user device 106, the network device 104, the voice controlled device 108, or a combination thereof.

The services device 107 may be configured to provide one or more services, such as account services, application services, network services, content services, or a combination thereof. The services device 107 may comprise services for one or more applications on the user device 106. The services device 107 may generate application data associated with the one or more application services. The application data may comprise data for a user interface, data to update a user interface, data for an application session associated with the user device 106, and/or the like. The application data may comprise data associated with access, control, and/or management of the premises 116. The application data may comprise the premises data, updates to the premises data, and/or the like.

The services device 107 may be configured to determine to send information (e.g., configuration settings, notifications, information about the premises) to the user device 106, the network device 104, or a combination thereof. The services device 107 may comprise information rules associating various values, patterns, account information, and/or the like with corresponding information. The services device 107 may detect a change in the premises data from the one or more premises devices. The services device 107 may analyze the premises data and determine that an information rule is triggered. The information may be sent to the user device 106 based on the information rule being triggered and/or satisfied. The information may comprise at least a portion of the premises data, such as wireless information (e.g., received signal strength, or other wireless metrics), an image, video, sensor state (e.g., motion detected, window open, window closed, door open, door closed, temperature, measured particle level, smoke detected, heat detected) and/or the like. The information may comprise a configuration setting of the network device 104, the voice controlled device 108, the user device 106, the one or more premises devices 110.

The voice controlled device 108 may comprise a smart speaker, such as a device comprising a speaker, a computer processor (e.g., or micro-controller), and a microphone. The voice controlled device 108 may be configured to receive voice commands from users at the premises 116. Voice commands may comprise any command, such as buying a product, adding an item to a list, playing content, providing an answer to a question (e.g., via querying a search engine), and/or the like.

The user device 106 may comprise a computing device, a smart device (e.g., smart glasses, smart watch, smart phone), a mobile device, a tablet, a computing station, a laptop, a digital streaming device, a set-top box, a streaming stick, a television, and/or the like. In some scenarios, a user may have multiple user devices, such as a mobile phone, a smart watch, smart glasses, a combination thereof, and/or the like. The user device 106 may be configured to communicate with the network device 104, the content device 102, the voice controlled device 108, the one or more premises devices 110, and/or the like. The user device 106 may be configured to output a user interface. The user interface may be output via the user interface via an application, service, and/or the like, such as a content browser. The user interface may receive application data from the services device 107. The application data may be processed by the user device 106 to cause display of the user interface.

The user interface may be displayed on a display of the user device 106 (e.g., or a display communicatively coupled with the user device 106). The display may comprise a television, screen, monitor, projector, and/or the like. The user interface may comprise a premises management application, a premises automation application, a content management application (e.g., for accessing video, audio, gaming, and/or other media), a smart assistant application, a virtual assistant application, a premises security application, network services application, or a combination thereof. The user interface may be configured to output status information associated with the premises (e.g., status information of the one or more premises device 110 and/or network device 104). The application may be configured to allow control of and/or sending commands to the premises 116 (e.g., to the one more premises devices 110, the voice controlled device 108, and/or the network device 104). The user interface may be configured to allow a user to configure settings associated with the network device 104, the voice controlled device, and/or the like.

The network device 104 may be comprise a computing device, a gateway device, an access point (e.g., wireless access point), a router, a modem, device controller (e.g., automation controller, security controller, premises health controller, content device controller) a combination thereof, and/or the like. The network device 104 may be configured to communicate using the one or more second networks 114 at the premises 116. The network device 104 may be configured to implement one or more services associated with the content device 102 and/or services device 107 (e.g., or with the premises 116, a user account), such as a content service, a premises service, a voice controlled service, an automation service, a security service, a health monitoring service, or a combination thereof.

One or more devices of the system 100 may be configured to cause adjustment of a volume of a computing device at the premises 116. The volume may be adjust based on changes in a configuration of the premises, such as a change in a number of people in one or more rooms of the premises. For purposes of illustration, the user device 106 is described below as determining a change in volume and causing the change in volume, but any of the other devices, such as the network device 104, the voice controlled device 108, the one or more premises devices 110, the services device 107, the content device 102, and/or any combination thereof, may be configured to determine a change in volume and cause a change in the volume. A determination to change the volume may be based on wireless information, such as received signal strength measurements. In some scenarios, analysis of the wireless information may be performed remotely, such as by another device at the premises or by a device external to the premises (e.g., the content device 102, the services device 107). Received signal strength measurements are used as example wireless information in the examples below, but other wireless information may be measured, calculated, and/or analyzed to determine to change the volume.

The user device 106 may be configured to determine a plurality of received signal strength measurements associated with at least one wireless radio located at the premises 116. The at least one radio may comprise a radio of the user device 106. The at least one wireless radio may be in another device, such as the network device 104, premises device 110, voice controlled device, or other computing devices at the premises 116. The plurality of received signal strength measurements may comprise measurements taken at a plurality of different times (e.g., or time periods). In some scenarios, measurements may be taken in intervals, such as 60 second time periods, and the measurements may be averaged over the interval.

The plurality of received signal strength measurements may comprise a first plurality of received signal strength measurements (e.g., measured during a first time and/or time period). The first plurality of signal strength measurements may be used to determine a baseline received signal strength associated with a baseline volume level at the premises. The baseline volume level may be associated with satisfying a threshold loudness expected to allow one or more users to hear content for a specific noise characteristic of the premises. The first plurality of received signal strength measurements may be analyzed (e.g., by the user device 106, by the network device 104, by the voice controlled device 108, by the services device 107) to determine one or more of trends, patterns, probabilities or features indicative of a baseline state of the received signal strength measurements. In some scenarios, the user device 106 may send collected wireless information (e.g., the first plurality of receive signal strength measurements) and send the wireless information to another device, such as another device at the premises 116 and/or another device external to the premises (e.g., the services device 107). The first plurality of received signal strength measurements may be analyzed based on one or more of: a model, a machine learning model, a data store associating wireless measurement information with corresponding volume levels, user settings, user feedback (e.g., changing the volume and an associated wireless measurement information), premises sensor data (e.g., infrared data, door openings, motion data), device detection data (e.g., detection of a number of devices in the area by detecting wireless signals from each device), camera data, device usage data (e.g., number or change in devices connected to a router and/or gateway), or content consumption data. Determining the baseline received signal may comprise inputting an indication of the first plurality of received signal strength measurements into a machine learning model configured to determine one or more of a baseline state or a baseline count of objects in at least a portion of the premises.

The user device 106 (e.g., or the network device 104, the voice controlled device 108, the services device 107, the premises device 110, the content device 102) may be configured to determine a volume level for output of content via the user device 106 (e.g., or other computing device) at the premises 116. The volume level may be determined based on the plurality of received signal strength measurements. The plurality of received signal strength measurements may be taken at a plurality of different times (e.g., or time periods, time intervals). Received signal strength measurements may be periodically taken, and compared (e.g., or averages over time may be compared) to determine the change in the received signal strength measurements. Determining the volume level may comprise determining a change in a volume level, volume adjustment, and/or an amount to modify the volume level. The volume adjustment may be applied to a prior volume level, such as the current volume level, a recent volume level, or the baseline volume level. The determined volume level and/or change in the volume level may be associated with satisfying a threshold loudness expected to allow one or more users to hear the content for a specific noise characteristic of the premises. A different threshold loudness may be used for different levels of received signal strength measurements.

An adjustment to the baseline volume level may be caused based on the baseline received signal strength (e.g., or any other prior received signal strength measurement and/or metric determined from prior received signal strengths) and at least one second received signal strength measurement. The amount of the adjustment may be determined based on a comparison of the baseline received signal strength and the at least one second received signal strength. The amount of the adjustment may be applied to the baseline volume level.

The amount (e.g., or change in the volume level) may be based on determining a threshold amount of change in received signal strength between a first portion of the plurality of received signal strength measurements and a second portion of the plurality of received signal strength measurements. In some scenarios, the amount may be based on determining a threshold amount of change between a baseline received signal strength and a second received signal strength measurement.

In some scenarios, the volume adjustment (e.g., or amount to modify the volume level) may be based on a user preference. The user device 106 may be configured to determine the user preference. The volume level may be based on the user preference (e.g., user interface, setting for up or down). The user preference may comprise a specific amount (e.g., decibels, volume level change) to change the volume. A user may enter the preference into the user interface. The user preference may be determined based on actions associated with the user, such as adjustments and/or refinements to the volume by the user (e.g., to change from the computer determined adjustments). The user preference may comprise a threshold, such as a threshold change in the number of people detected, and/or a threshold change in wireless information (e.g., received signal strength measurements). The user preference may comprise a direction to change the volume, such as whether to increase or decrease the volume. For example, some users may prefer the volume to be adjusted down if a number of people at the premises 116 increases. Other users may prefer instead for the volume to be adjusted up if the number of people at the premises 116 increases.

The user device 106 (e.g., or network device 104, voice controlled device 108, services device 107, premises device 110, content device 102) may be configured to determine a change in the volume based on a volume control rule. The user device 106 may be configured to determine that a change in a wireless metric (e.g., wireless signal strength) associated with the at least one wireless radio located at the premises satisfies the volume control rule. The volume control rule may comprise a trigger condition indicating a threshold amount of change in wireless signal strength. The volume control rule may be satisfied based on the change exceeding the threshold. The volume control rule may comprise an action indicating an amount to change the volume level. The change in volume level may be determined based on the volume control rule. The change in volume level may be based on the action indicated in the volume control rule. For example, different actions may be associated with different changes in volume levels. Different threshold conditions (e.g., different threshold amounts of change) may be associated with corresponding changes in volume levels. A change in volume may not be triggered unless the threshold conditions are satisfied.

Determining the change in volume level may comprise determining a received signal strength metric and applying one or more parameters to the metric. The received signal strength metric may comprise an average of signal strength measurements during a time period. The received signal strength metric may comprise data indicative of the baseline received signal strength. The one or more parameters may comprise a first parameter. Applying the one or more parameters may comprise adding or subtracting the first parameter to the received signal strength metric. For example, the first parameter may comprise a first constant that is subtracted from received signal strength metric (e.g., the baseline received signal strength, average or mean received signal strength). The one or more parameters may comprise a second parameter. Applying the one or more parameters may comprise adding or subtracting the second parameter to a result of applying the first parameter to the received signal strength metric. The second parameter may comprise a second constant that is added to the result of applying the first parameter to the received signal strength metric.

The following is an example equation for volume control:

$$( {X}^{-} - {p}_{1} ) + {p}_{2} ) = Y \qquad ( Eq 1. )$$

$$( {X}^{-} T - {p}_{1} ) + {p}_{2} ) = Y \qquad ( Eq 2. )$$

where
   X=RSSI or Signal Strength dBm (or other wireless measurement)
   X⁻=Mean or Average of X
   XT⁻Mean or Average of X over T
   Y=Volume dB

Equation 1 may represent a basic increase equation. Equation 2 may represent an increase equation average over time. The values of p₁ (e.g., the first parameter) and p₂ (e.g., the second parameter) may be different for different wireless chipset vendors due to different receiver sensitivity and/or RSSI scales. As just one example illustration, p₁ could be 2 (in dB) and p₂ could be 3. Other numbers may be used for p and p₂. In some scenarios, the X may represent other information, such as channel state information. The first parameter p₁ and the second parameter p₂ may be selected to any appropriate number associated with channel state information.

A few examples are provided by way of explanation on how these equations may be used. The user device 106 may be configured to determine to increase volume based on a decrease in received signal strength indicators. If average received signal strength indicator over a 60 s period sampled over the current beacon rate decreases by a value of 2, then the user device 106 may decrease the volume by 3 dB. The user device 106 may be configured to determine to decrease volume based on an increase in received signal strength indicator. If the average received signal strength indicator over a 60 s period sampled over the current beacon rate increases by a value of 2, then the user device 106 may decrease volume by 3 dB. The user device 106 may be configured to determine to increase volume based on an increase in signal strength. If the average signal strength over a 60 s period sampled over the current beacon rate decreases by a value of 2 dBm, then the user device 106 may increase volume by 3 dB. The user device 106 may be configured to determine to decrease volume based on a decrease in signal strength. If the average signal strength over a 60 s period sampled over the current beacon rate decreases by a value of 2 dBm, then the user device 106 may increase volume by 3 dB.

The user device 106 (e.g., or network device 104, voice controlled device 108, services device 107, premises device 110, content device 102) may be configured to determine an estimated count of a number of people (e.g., or other objects) in an area (e.g., a room, floor, zone) of the premises 116. The volume level may be determined based on one or more of the estimated count or a change in the estimated count. Different received signal strength measurements may be associated with different numbers of people in the area of the premises. The second received signal strength measurements may be used to determine the count of the number of people. In some scenarios, a prompt may be provided on the user interface indicating to the user the number of people detected in the room. The user may correct the number to allow for calibration and/or refinement of what received signal strength measurements (e.g., or other wireless information) correlate to which numbers of people in the room. Other refinement approaches may be used, such as image analysis of a camera at the premises (e.g., to recognize the number of different people in the area), voice detection, detection of a number of different wireless devices in the area of the premises, a combination thereof, and/or the like. Additionally, a specific number of people may be associated with a range of received signal strength measurements.

The user device 106 (e.g., or network device 104, voice controlled device 108, services device 107, premises device 110, content device 102) may be configured to cause output of the content at the determined volume level. The output may be caused at the user device 106 and/or at another computing device, such as a display device, an audio device (e.g., wireless speaker, wired speaker, audio transceiver, smart speaker, sound bar), and/or the like. The user device 106 may be configured to cause (e.g., the user device 106, or the computing device) adjustment of the volume level. The determined volume level may be associated with satisfying a threshold loudness expected to allow one or more users to hear the content for a specific noise characteristic of the premises. Causing output of the content at the determined volume level may comprise one or more of sending a message via a network to the computing device or updating (e.g., by the user device 106, by the computing device), a volume setting of a content player of user device 106 (e.g., or of the computing device). In scenarios where a different computing device determines the volume level, the different device may send a command to the user device 106 to use the determined volume level.

FIG. 2A shows an example premises, such as the premises 116 of FIG. 1. Any of the features or elements of FIG. 1 may be incorporated in the example premises shown in FIG. 2A. In particular, FIG. 2A shows an example premises 200 of a user 202. The premises 200 may comprise a plurality of rooms (e.g., or areas), such as a sitting room 204, a dining room 206, a kitchen 208, a living room 210, and/or the like. The premises 200 may comprise one or more first computing devices 212. The one or more first computing devices 212 may comprise any of the features of the voice controlled device 108 of FIG. 1. The one or more first computing devices 212 may comprise third party devices, virtual assistant devices, voice controlled devices, a speaker, a smart speaker, a controller, and/or the like.

The premises 200 may comprise a second computing device 214. The second computing device 214 may comprise a content device, a digital streaming device, a set-top box, and/or the like. The second computing device 214 may be configured to communicate with a display device 215. The display device 215 may comprise a display and/or audio speakers for outputting audio. The second computing device 214 may be configured to cause content, such as video and/or audio, to be displayed on the display device 215. The second computing device 214 may comprise any of the features of the user device 106 of FIG. 1.

The premises 200 may comprise a third computing device 224. The third computing device may comprise a service provider device, a controller (e.g., remote control), a virtual assistant device, a voice controlled device, a controller, a television controller, a set-top box controller, mobile device, mobile phone, smart phone, tablet device, and/or the like. In some scenarios, the third computing device 224 may comprise any of the features of the user device 106 of FIG. 1.

The premises 200 may comprise a network device 216. The network device 216 may comprise the network device 104 of FIG. 1. The network device 216 may comprise a gateway, a router, a modem (e.g., a cable modem), a switch, or a combination thereof. The network device 216 may be configured to communicate (e.g., via one or more local networks, such as a wireless network, shown via dashed arrows) with any of the devices at the premises 200. The network device 216 may be configured to communicate (e.g., via a wide area network, fiber network, coaxial network, and/or the like) with devices external to the premises 200, such as server device 218 and one or more network nodes 220, and/or the like.

The second computing device 214 may be configured to perform a first set of wireless measurements. The first set of wireless measurements may be performed during a first time period. The first set of wireless measurements may be performed by determining wireless measurements based on communication between one or more devices at the premises 200. For example, the second computing device 214 may determine wireless measurements associated with communication between the second computing device 214 and the third computing device 224. The second computing device 214 may determine wireless measurements associated with communication between the second computing device 214 and one or more first computing devices 212. The second computing device 214 may determine wireless measurements associated with communication between the second computing device 214 and the network device 216. In some scenarios, the network device 216, the third computing device 224, or the one or more first computing devices 212 may perform the wireless measurements (e.g., instead or in addition to the second computing device 214).

During the first time period, the user 202 may be the only person in the premises 200 (e.g., or the only person in an area of the premises). The first set of wireless measurements may comprise any type of wireless information, such as received signal strength indicators, signal strength, and/or the like. The first set of wireless measurements may be combined with any other relevant information, such as other sensor measurements at the premises 200. The first set of wireless measurements may be used to calculate a baseline metric indicative of a baseline state of the premises 200. The baseline metric may be periodically recalculated. The baseline metric may represent the typical scenario (e.g., or a recent scenario) of the premises 200. The baseline metric may be calculated by averaging the first set of wireless measurements.

As shown in FIG. 2B, the number of people at the premises may increase. For example, an event, such as a party may cause additional individuals to arrive. The increase in people may make it difficult to hear the content being output (e.g., via the display device 215, or via the third computing device 224). The people may engage in conversations that may make listening to an audio portion of the content more difficult. The second computing device 214 may determine a second set of wireless measurements. As explained in further detail, herein the second computing device 214 may determine whether to cause a change to the volume of the second computing device 214 based on the second set of wireless measurements. A volume control rule may be used to determine whether a threshold amount of change has occurred between the first set of wireless measurements and the second set of wireless measurements. The second set of wireless measurements may show (e.g., if compared to the first set of wireless measurements) an increase in signal disruption due to the present of additional people in the premises 200. Equation 1 and/or Equation 2 may be used to determine an amount of change and/or a specific volume level to use. The second computing device 214 may cause adjustment of a volume level associated with the content. The second computing device 214 may send a command to the display device 215 to increase the volume level (e.g., to a specific volume level). If the content (e.g., audio) is being output via another device, such as one of the first computing devices 212 (e.g., a speaker device), then the second computing device 214 may send a command to the first computing device 212 to adjust the volume level. If no content is being played, the audio level may pre-emptively be adjusted by sending a command to set the volume level. If a user plays content, then the content will be output at the set volume level.

In some scenarios, the actions performed by the second computing device 214 may be performed by any other device at the premises, such as the network device 216, the third computing device 224, and/or the one or more first computing device 212.

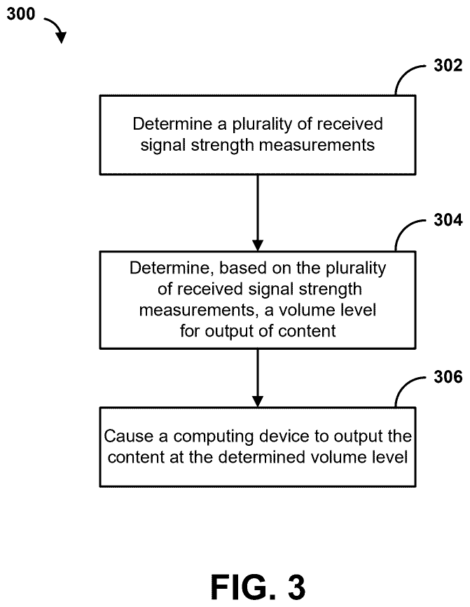

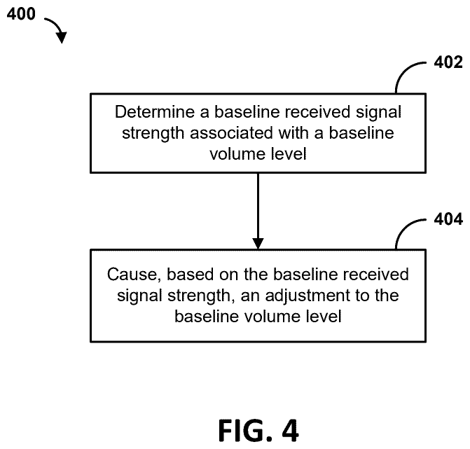

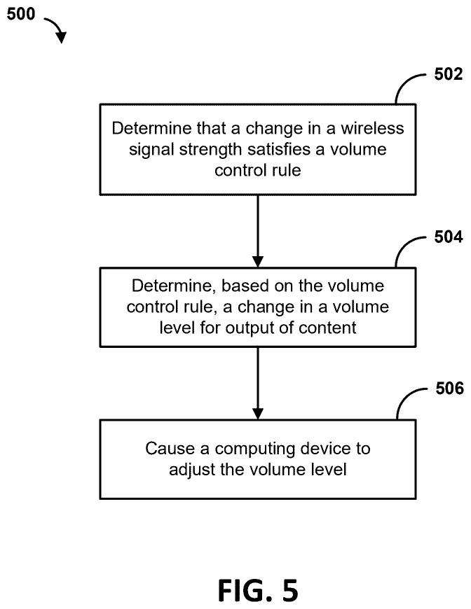

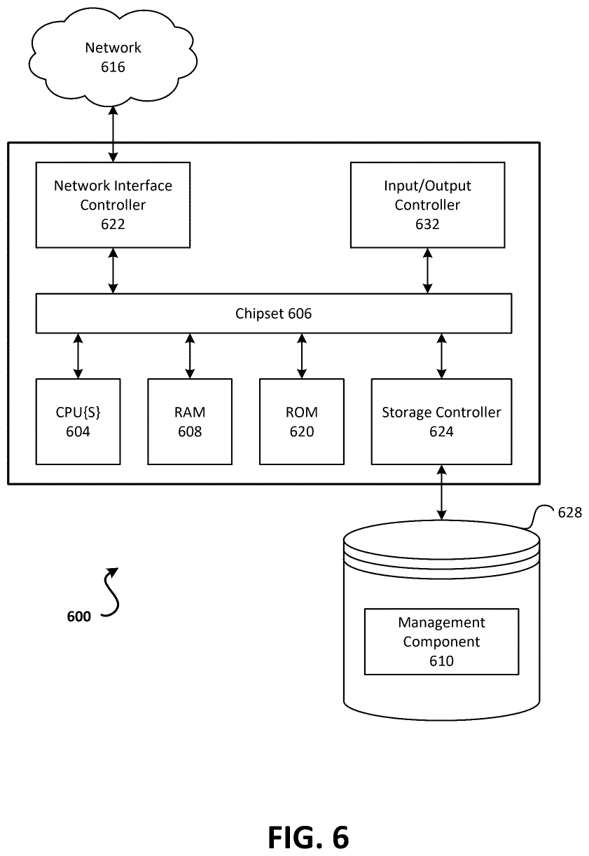

FIG. 3 shows an example method. The method 300 may comprise a computer implemented method for providing a service (e.g., content service, a network service, a communication service). A system and/or computing environment, such as the system 100 of FIG. 1 and/or the computing environment of FIG. 6, may be configured to perform the method 300. The method 300 may be performed in connection with the system illustrated in FIG. 1. Any step or combination of steps of the method 300 may be performed by a computing device, network device, network node, server device, user device, and/or premises device, such as any of the devices shown in FIG. 1 (e.g., the user device 106, the network device 104, the voice controlled device 108, the one or more premises devices 110, the services device 107, the content device 102), and/or the devices shown in FIG. 2A-B (e.g., the first computing device 212, the second computing device 214, the third computing device 224, the display device 215, the network device 216, network node 220, server device 218). Any of the features of the methods of FIGS. 4 and 5 may be combined with any of the features and/or steps of the method 300 of FIG. 3.

At step 302, a plurality of received signal strength measurements (e.g., or other wireless information) may be determined (e.g., received, measured, generated, accessed) via a computing device. The computing device may be comprised of at least one wireless radio. The plurality of received signal strength may be associated with at least one wireless radio. At least one wireless radio may be located at a premises (e.g. a living room, a conference room, a sports bar, etc.). An additional separate computing device may be comprised of at least one wireless radio. The at least one wireless radio may include a plurality of wireless radios that may belong to several computing devices. The plurality of received signal strength measurements may comprise measurements taken at different times (e.g., or time periods). Determining the received signal strength measurements may comprise the computing device receiving signal strength measurements from the several aforementioned computing devices. In some scenarios, the computing device may perform the measurements utilizing the wireless radio that may be comprised in the computing device. Other wireless information that may be used in addition to or instead of the received signal strength measurements may comprise Bluetooth, Wi-Fi, cellular signal, a combination of, and/or the like.

At step 304, a volume level for output of content (e.g., audio, video, etc. and/or any combination of the like) via a computing device at the premises may be determined. The output of content may be via a computing device (e.g., the user device 106 of FIG. 1, the second computing device 214, the one or more first computing devices 212, the third computing device 224, the display device 215 of FIGS. 2A-B). The volume level may be determined based on the plurality of received signal strength measurements. The computing device may be and/or comprise a media player, content player, user device, mobile device, set top box, and/or media streaming device. The computing device may be located at the premises. Determining the volume level may comprise determining a volume adjustment and determining the volume level by applying the volume adjustment to a prior volume level. Determining the volume level may comprise determining a user preference and an amount to modify the volume level. The volume level may be based on the user preference (e.g., user interface, setting for up or down, amount to increase or decrease). Determining the volume level, based on the plurality of received signal strength measurements, may comprise determining a received signal strength metric and applying one or more parameters to the metric (e.g., if additional people enter a room, thereby affecting the signal strength measurements, an appropriate volume level for the change in the number of people may be determined so everyone can hear). The received signal strength metric may be calculated based on the plurality of received signal strength measurements. For example, the plurality of received signal strength measurements may be calculated based on determining an average, mean, and/or the like of the plurality of received signal strength measurements.

At step 306, the computing device may be caused to output the content at the determined volume level. The content may be output in a variety of places, such as a premises, an area of a premises, a room, an outdoor location, a business location, and/or the like. The volume level determined may be based on the location, type of location, characteristics of the location, and/or the like. One example implementation may occur in a conference room comprising the computing device. As people enter the conference room, the computing device may detect changes in received signal strength associated with one or more wireless connections. The one or more wireless connection may comprise a wireless connection with an access point, a wireless connection with a user device (e.g., of a person in the room or entering the room), and/or the like. The computing device (e.g., or other device) may observe a change in the received signal strength as more people enter the room. The computing device may increase the volume based on the change. In some scenarios, the decision to increase the volume may be based (e.g., alternatively based or based in addition to the use of received signal strength) on other information, such as the detection of one or more users' devices (e.g., that were not detected before). As people leave the room, a change in the received signal strength may be detected, and the volume of the computing device may be decreased.

The one or more parameters may comprise a first parameter (e.g., p₁ of equations 1 and 2). Applying the one or more parameters may comprise adding or subtracting the first parameter to the received signal strength metric. The one or more parameters may comprise a second parameter (e.g., p₂ of equations 1 and 2). Applying the one or more parameters may comprise adding or subtracting the second parameter to a result of applying the first parameter to the received signal strength metric. The amount may be based on determining a threshold amount of change in received signal strength between a first portion of the plurality of received signal strength measurements and a second portion of the plurality of received signal strength measurements.

In some scenarios, an estimated count of a number of people (e.g., or other objects) in an area of premises (e.g., a room, floor, zone) may be determined. Determining the volume level may be based on the estimated count and/or a change in the estimated count.

In an example scenario, a user may start streaming a sports game. As the game progresses, more people show up at the user's premises. A set top box (e.g., digital streaming device) may start taking measurements of the received signal strength. The received measurements indicate that there has been a large influx in people. The set top box will then increase the volume of the game in order to ensure that everyone present in the space can hear. As the game comes to a close and the user's guest begin to dissipate, the received signal strength may decrease, therefore causing the volume to decrease at the premises.

FIG. 4 shows an example method. The method 400 may comprise a computer implemented method for providing a service (e.g., content service, a network service, a communication service). A system and/or computing environment, such as the system 100 of FIG. 1 and/or the computing environment of FIG. 6, may be configured to perform the method 400. The method 400 may be performed in connection with the system illustrated in FIG. 1. Any step or combination of steps of the method 400 may be performed by a computing device, network device, network node, server device, user device, and/or premises device, such as any of the devices shown in FIG. 1 (e.g., the user device 106, the network device 104, the voice controlled device 108, the one or more premises devices 110, the services device 107, the content device 102), and/or the devices shown in FIG. 2A-B (e.g., the first computing device 212, the second computing device 214, the third computing device 224, the display device 215, the network device 216, network node 220, server device 218). Any of the features of the methods of FIGS. 3 and 5 may be combined with any of the features and/or steps of the method 400 of FIG. 4.

At step 402, a baseline received signal strength associated with a baseline volume level at the premises may be determined. The baseline received signal strength associated with a baseline volume level at the premises may be determined based on a first plurality of received signal strength measurements associated with at least one wireless radio located at a premises. The first plurality of received signal strength measurements may comprise measurements taken at several different times (e.g., or time periods). The baseline volume level may be associated with satisfying a threshold loudness that may allow one or more users to hear content for a specific noise characteristic of the premises. The at least one wireless radio may be comprised in a computing device determining the first plurality of received signal strength measurements. The at least one wireless radio may be comprised in an additional computing device different from the computing device. The additional computing device may determine the first plurality of received signal strength measurements. Determining the baseline received signal strength may comprise analyzing the first plurality of received signal strength measurements to determine one or more of trends, patterns, probabilities or features indicative of a baseline state of the received signal strength measurements.

The baseline received signal strength may be determined by analyzing the first plurality of received signal strength measurements based on one or more of user feedback, premises sensor data, camera data, device usage data, or content consumption data. The baseline received signal may be determined by inputting an indication of the first plurality of received signal strength measurements into a machine learning model. The machine learning model may be configured to determine one or more of a baseline state or a baseline count of objects in at least a portion of the premises.

At step 404, an adjustment to the baseline volume level may be caused. An adjustment to the baseline volume level may be caused based on the baseline received signal strength and one or more additional received signal strength measurements. The adjustment may be based on applying one or more parameters to data indicative of the baseline received signal strength (e.g., as shown in equations 1 and 2). The adjustment may be based on a user preference (e.g., user interface, setting for up or down). The adjustment may be based on one or more of the estimated count or a change in the estimated count. Adjustment to the baseline volume level may be caused by determining an amount of the adjustment based on a comparison of the baseline received signal strength and one or more additional received signal strength and applying the adjustment to the baseline volume level.

FIG. 5 shows an example method. The method 500 may comprise a computer implemented method for providing a service (e.g., content service). A system and/or computing environment, such as the system 100 of FIG. 1 and/or the computing environment of FIG. 5, may be configured to perform the method 500. The method 500 may be performed in connection with the system illustrated in FIG. 1. Any step or combination of steps of the method 300 may be performed by a computing device, network device, network node, server device, user device, and/or premises device, such as any of the devices shown in FIG. 1 (e.g., the user device 106, the network device 104, the voice controlled device 108, the one or more premises devices 110, the services device 107, the content device 102), and/or the devices shown in FIG. 2A-B (e.g., the first computing device 212, the second computing device 214, the third computing device 224, the display device 215, the network device 216, network node 220, server device 218). Any of the features of the methods of FIGS. 3 and 4 may be combined with any of the features and/or steps of the method 500 of FIG. 5.

At step 502, a determination may be made that a change in a wireless signal strength associated with at least one wireless radio located at a premises satisfies a volume control rule. The volume control rule may comprise a trigger condition indicating a threshold amount of change in wireless signal strength. The volume control rule may be satisfied based on the change exceeding the threshold. The volume control rule may comprise an action indicating an amount to change the volume level. The change in the wireless signal strength may be based on a plurality of received signal strength measurements taken at a plurality of different times. The at least one wireless radio may be comprised in a computing device determining the plurality of received signal strength measurements. The computing device determining the plurality of received signal strength measurements may comprise one of the computing devices at the premises or an additional computing device.

At step 504, a change in a volume level for output of content (e.g., audio, video, etc. and/or any combination of the like) via a computing device at the premises may be determined. The change in a volume level for output of content via a computing device at the premises may be determined based on the volume control rule. The change in volume level may be based on the action. Determining the change in the volume level may comprise determining a volume adjustment and determining the volume level by applying the volume adjustment to a prior volume level. The change in the volume level may be associated with satisfying a threshold loudness expected to allow one or more users to hear the content for a specific noise characteristic of the premises. Determining the change in volume level may comprise determining a received signal strength metric and applying one or more parameters to the metric (e.g., by using equation 1 and/or equation 2). The one or more parameters may comprise a first parameter. Applying the one or more parameters may comprise adding or subtracting the first parameter to the received signal strength metric. The one or more parameters may comprise a second parameter. Applying the one or more parameters may comprise adding or subtracting the second parameter to a result of applying the first parameter to the received signal strength metric.

Determining the change in the volume level may comprise determining an amount to modify the volume level. Determining the change in the volume level may comprise determining a user preference. The change in the volume level may be based on the user preference (e.g., user interface, setting for up or down, amount to increase or decrease). An estimated count of a number of people (e.g., or other objects) in an area of premises (e.g., a room, floor, zone) may be determined. Determining the change in the volume level may be based on one or more of the estimated count or a change in the estimated count.

The change in the volume level be determined based on determining a threshold amount of change in received signal strength between a first portion of a plurality of received signal strength measurements (e.g., from a first time period) and a second portion of the plurality of received signal strength measurements (e.g., from a second time period, the current time period)

At step 506, the computing device may be caused to adjust the volume level may. Causing the computing device to adjust the volume level may comprise one or more of sending a message via a network to the computing device or updating, by the computing device, a volume setting of a content player of the computing device.

FIG. 6 depicts a computing device that may be used in various aspects, such as the servers, modules, and/or devices depicted in FIG. 1 and FIG. 2A-B. With regard to the example architecture of FIG. 1, the content device 102, services device 107, network device 104, user device 106, voice controlled device 108, premises device 110 may each be implemented in an instance of a computing device 600 of FIG. 6. With regard to the example architecture of FIG. 2A-B, the one or more first computing devices 212, the second computing device 214, the third computing device 224, the display device 215, the network device 216, the network node 220, and the server device 218 may each be implemented in an instance of a computing device 600 of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 1, FIG. 2A-B, FIG. 3, FIG. 4, FIG. 5, and FIG. 6.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may include one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 1, FIGS. 2A-B, FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

The term “or” when used with “one or more of” is used in its inclusive sense (and not in its exclusive sense) so that when used, for example, to connect a list of elements, the term “or” means one, some or all of the elements in the list. The term “or” when used with “at least one of” is used in its inclusive sense (and not in its exclusive sense) so that when used, for example, to connect a list of elements, the term “or” means one, some or all of the elements in the list. For example, the phrases “one or more of A, B, or C” includes any of the following: A, B, C, A and B, A and C, B and C, and A and B and C. Similarly the phrase “one or more of A, B, and C” includes any of the following: A, B, C, A and B, A and C, B and C, and A and B and C. The phrase “at least one of A, B, or C” includes any of following: A, B, C, A and B, A and C, B and C, and A and B and C. Similarly, the phrase “at least one of A, B, and C” includes any of following: A, B, C, A and B, A and C, B and C, and A and B and C.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
determining a plurality of received signal strength measurements associated with at least one wireless radio located at a premises;
determining, based on the plurality of received signal strength measurements, a volume level for output of content via a computing device at the premises; and
causing the computing device to output the content at the determined volume level.

2. The method of claim 1, wherein the plurality of received signal strength measurements comprises measurements taken at a plurality of different times.

3. The method of claim 1, wherein determining the volume level comprises determining a volume adjustment and determining the volume level by applying the volume adjustment to a prior volume level.

4. The method of claim 1, wherein the determined volume level is associated with satisfying a threshold loudness expected to allow one or more users to hear the content for a specific noise characteristic of the premises.

5. The method of claim 1, wherein the at least one wireless radio is comprised in the computing device, and wherein the computing device is configured to determine the plurality of received signal strength measurements.

6. The method of claim 1, wherein determining, based on the plurality of received signal strength measurements, the volume level comprises determining a received signal strength metric and applying one or more parameters to the metric.

7. The method of claim 1, wherein determining the volume level comprises determining an amount to modify the volume level, wherein the amount is based on determining a threshold amount of change in received signal strength between a first portion of the plurality of received signal strength measurements and a second portion of the plurality of received signal strength measurements.

8. A method comprising:
determining, based on a first plurality of received signal strength measurements associated with at least one wireless radio located at a premises, a baseline received signal strength associated with a baseline volume level at the premises; and
causing, based on the baseline received signal strength and at least one second received signal strength measurement, an adjustment to the baseline volume level.

9. The method of claim 8, wherein the first plurality of received signal strength measurements comprises measurements taken at a plurality of different times.

10. The method of claim 8, causing the adjustment to the baseline volume level comprises determining an amount of the adjustment based on a comparison of the baseline received signal strength and the at least one second received signal strength and applying the adjustment to the baseline volume level.

11. The method of claim 8, wherein the baseline volume level is associated with satisfying a threshold loudness expected to allow one or more users to hear content for a specific noise characteristic of the premises.

12. The method of claim 8, the adjustment is based on applying one or more parameters to data indicative of the baseline received signal strength.

13. The method of claim 8, wherein causing the adjustment is based on determining a threshold amount of change in received signal strength between the baseline received signal strength and the second received signal strength measurement.

14. The method of claim 8, wherein determining the baseline received signal strength comprises analyzing the first plurality of received signal strength measurements to determine one or more of trends, patterns, probabilities or features indicative of a baseline state of the received signal strength measurements.

15. A method comprising:
determining that a change in a wireless signal strength associated with at least one wireless radio located at a premises satisfies a volume control rule;
determining, based on the volume control rule, a change in a volume level for output of content via a computing device at the premises; and
causing the computing device to adjust the volume level.

16. The method of claim 15, wherein the change in the wireless signal strength is based on a plurality of received signal strength measurements taken at a plurality of different times.

17. The method of claim 15, wherein determining the change in the volume level comprises determining a volume adjustment and determining the volume level by applying the volume adjustment to a prior volume level.

18. The method of claim 15, wherein the change in the volume level is associated with satisfying a threshold loudness expected to allow one or more users to hear content for a specific noise characteristic of the premises.

19. The method of claim 15, wherein the volume control rule comprising a trigger condition indicating a threshold amount of change in wireless signal strength, and wherein the volume control rule is satisfied based on the change exceeding the threshold.

20. The method of claim 15, wherein determining the change in the volume level comprises determining a received signal strength metric and applying one or more parameters to the metric.
